(19) United States
(12) Patent Application Publication
(10) Pub. No.: US 2016/0296414 A1
(43) Pub. Date: Oct. 13, 2016

(54) VARIABLE COMPRESSION ROLLER APPARATUS

(71) Applicant: Bradley Cox, Stoneham, MA (US)

(72) Inventor: Bradley Cox, Stoneham, MA (US)

(21) Appl. No.: 14/942,286

(22) Filed: Nov. 16, 2015

Related U.S. Application Data
(60) Provisional application No. 62/145,295, filed on Apr. 9, 2015.

(51) Int. Cl. A61H 15/00

(52) U.S. Cl. CPC A61H 15/0092; A61H 2015/0021

(57) ABSTRACT

A variable compression roller apparatus which includes a compression member comprising a first end and an opposing second end and a recessed portion disposed between the first and second ends, the recessed portion having one or more force application zones configured to receive and apply a force to a target area of a user's body, wherein the recessed portion applies a first force to the received target area when in a first zone and a second force when in a second zone.

### CROSS-REFERENCE

This application claims the benefit under 35 U.S.C 119 (e) of U.S. Provisional Patent Application No. 62/145,295, filed on Apr. 9, 2015, the contents of which is incorporated by reference in its entirety.

### FIELD OF INVENTION

The present general inventive concept relates generally to a therapeutic device, and more particularly, to a variable compression roller apparatus that provides variable compressive pressure to a target area of a user.

### BACKGROUND

Conventional rollers include a basic cylindrical foam rollers that put even pressure on a user's body as the user rolls back and forth against the roller. The main innovations to date for these rollers are textural knobs on the surface of the roller for deeper penetration and rollers which vibrate. The textural knobs increase specific pressure and allow for oxygen and blood to flow through the muscle while being used, however, they are typically designed to be placed on an even surface and can only be used by direct downward pressure and not from a side wall. In addition, conventional rollers are unable to provide varying amounts of compression or pressure directly or laterally, which is desirable.

### BRIEF SUMMARY

The variable compression roller apparatus according to the present general inventive concept provides a release pattern of decreasing to increasing pressure and multiple pressure zones applied from multiple angles with respect to a target area.

The variable compression roller apparatus according to the present general inventive concept further provides a direct pressure bar to apply direct pressure.

The variable compression roller apparatus according to the present general inventive concept also provides a product (i.e., tool) for soft tissue myofascial release that has the ability to target multiple parts of the body with both direct and compressive pressure from the sides of the muscle (i.e., target area).

The variable compression roller apparatus further provides an increasing amount of sheer force by rolling the variable compression foam roller on a user's restricted/tight muscle or trigger point.

This variable compression roller apparatus also allows for the application of pressure in a way that mimics different types of therapeutic massage and soft tissue manipulations such as squeezing and releasing techniques and rolling and kneading techniques. Increasing compression on a muscle has been shown to improve blood flow and oxygen transportation and is an important part of rehabilitation and achieving peak athletic performance.

Additional features and embodiments of the present general inventive concept will be apparent from the following detailed description, drawings, and claims.

### BRIEF DESCRIPTION OF THE FIGURES

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1 is a front perspective view of a variable compression apparatus according to an exemplary embodiment of the present general inventive concept;

FIG. 2 is a top plan view of the variable compression apparatus illustrated in FIG. 1;

FIG. 3 is a front view of the variable compression apparatus illustrated in FIG. 1;

FIG. 4 is a bottom view of the variable compression apparatus illustrated in FIG. 1;

FIG. 5 is a front view of the variable compression apparatus illustrated in FIG. 1;

FIG. 6 is a side view of the variable compression apparatus illustrated in FIG. 1;

FIG. 7 is a front view of a compression member according to an exemplary embodiment of the present general inventive concept;

FIG. 8A is a front view illustrating a first pressure zone of a variable compression apparatus according to an exemplary embodiment of the present inventive concept;

FIG. 8B is a rotated front view illustrating a second pressure zone of the variable compression apparatus illustrated in FIG. 8A;

FIG. 9A is a schematic front view illustrating a target area disposed within the first pressure zone of the variable compression apparatus illustrated in FIG. 8A;

FIG. 9B is a schematic front view illustrating a target area disposed within the second pressure zone of the variable compression apparatus illustrated in FIG. 8A;

FIGS. 10A-10C are front views illustrating a variable compression apparatus according to an exemplary embodiment of the present general inventive concept acting on a target area, during rotation;

FIG. 11 is an exploded assembly perspective view of a variable compression apparatus according to another exemplary embodiment of the present general inventive concept;

FIGS. 12A-12J are top plan views illustrating a variable compression apparatus during a complete rotation according to another exemplary embodiment of the present general inventive concept;

FIG. 13 is front perspective view illustrating a variable compression apparatus according to an exemplary embodiment of the present general inventive concept positioned under a user's leg (i.e., target area);

FIG. 14 is front perspective view illustrating a variable compression apparatus according to an exemplary embodiment of the present general inventive concept positioned behind a user's shoulders (i.e., target area); and

FIG. 15 is force versus rotation chart of a variable compression apparatus according to an exemplary embodiment of the present general inventive concept.

### DETAILED DESCRIPTION

Reference will now be made to the example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein. Numerous variations, modification, and additional embodiments are possible, and, accordingly, all such variations, modifications, and embodiments are to be regarded as being within the spirit and scope of the present general inventive concept.

The present general inventive concept provides a therapeutic tool that concurrently provides both direct and variable compressive pressure to a user's body by rolling the tool (i.e., variable compression roller) on the user's restricted or tight muscles or trigger points (i.e., target areas). In addition, the therapeutic tool may also provide multiple types of pressure to the user's target areas in a way that mimics various different types of therapeutic massage and/or soft tissue manipulations such as squeezing and releasing techniques and/or rolling and kneading techniques. However, the present general inventive concept is not limited thereto.

Providing increasing and/or decreasing amounts of compression (i.e., compressive force) on a user's restricted muscles or other target areas has been shown to improve blood flow and oxygen transportation and is therefore an important part of rehabilitation and achieving peak athletic performance. In addition, the therapeutic tool according to the present general inventive concept provides for soft tissue myofascial release and has an ability to simultaneously target multiple target areas with both direct and compressive pressure from all sides of the muscle group or targeted area.

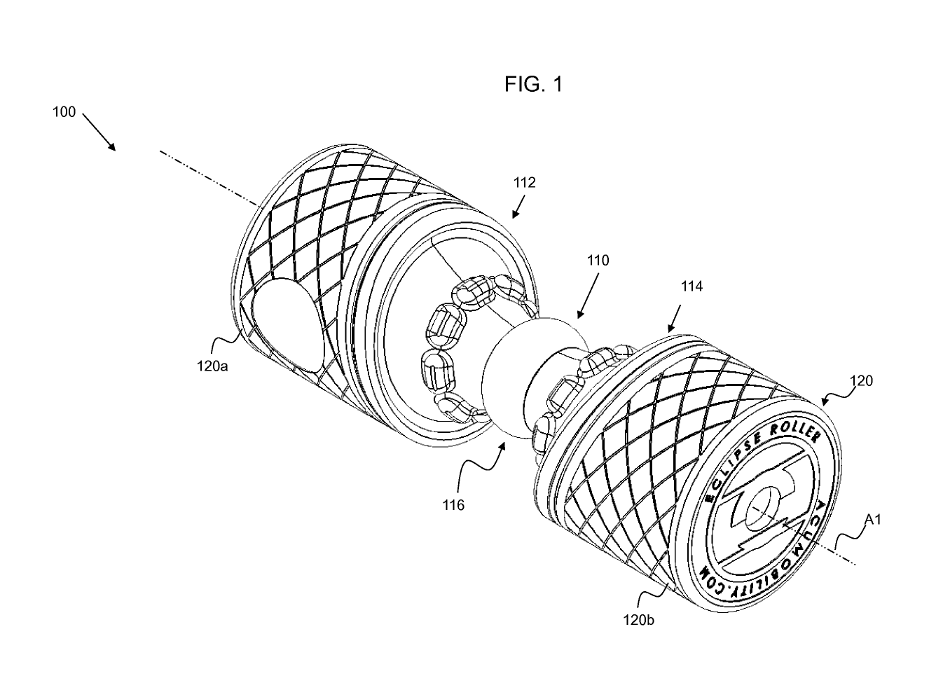

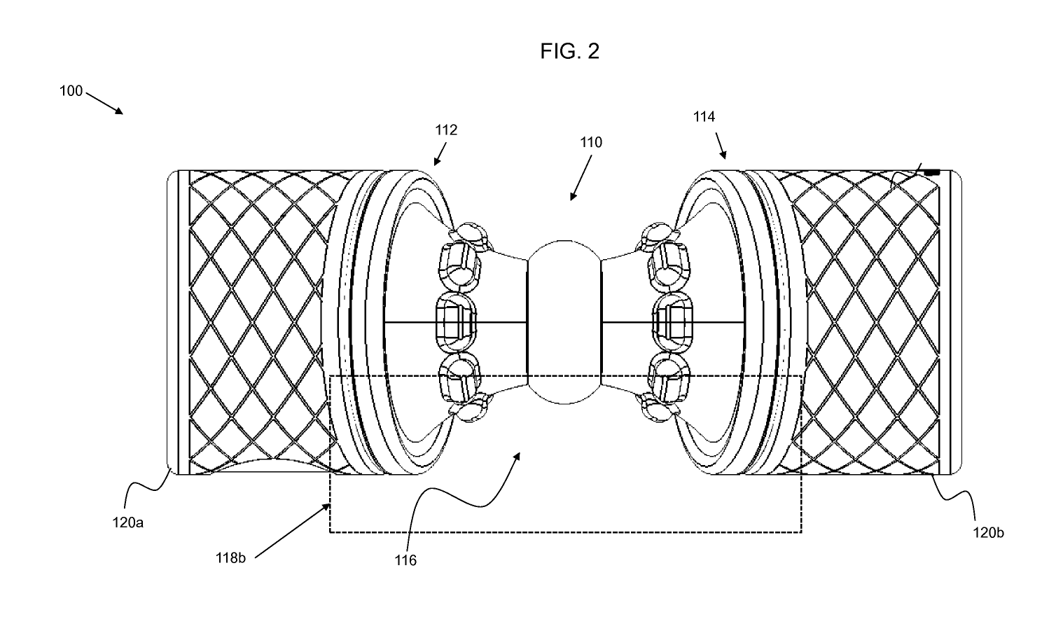

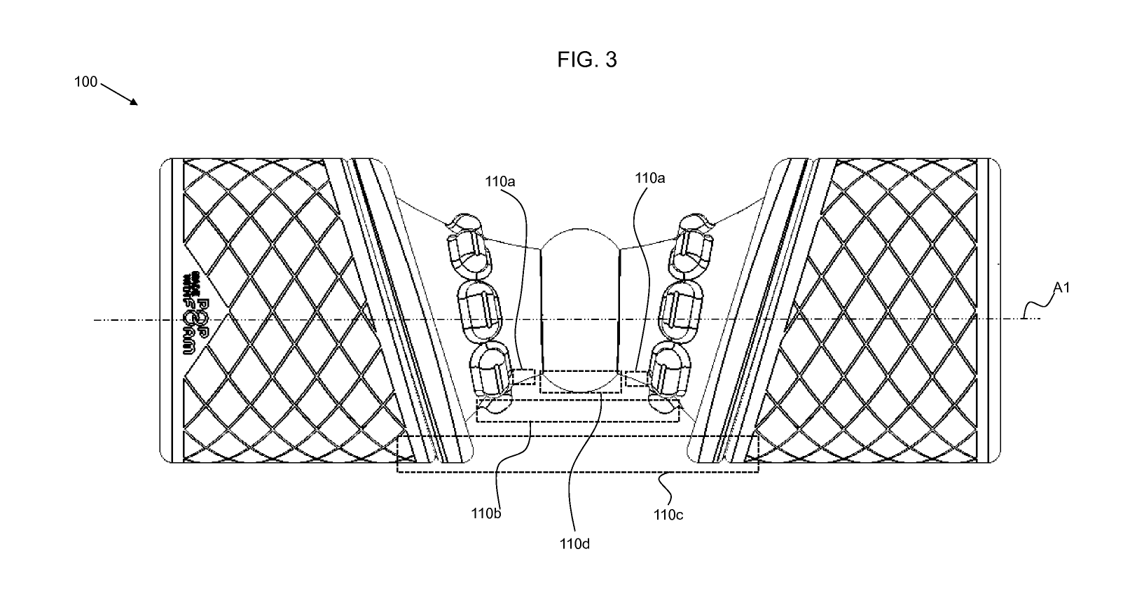

FIG. 1 is a front perspective view of a variable compression apparatus 100 according to an exemplary embodiment of the present general inventive concept. FIG. 2 is a top plan view of the variable compression apparatus 100 illustrated in FIG. 1 and FIG. 3 is a front view of the variable compression apparatus 100 illustrated in FIG. 1.

Referring to FIG. 1, the variable compression apparatus 100 includes a compression member 110 having a first end 112, an opposing second end 114, and a recessed portion 116 disposed between the first end 112 and the second end 114. In exemplary embodiments, the variable compression apparatus 100 may further include one or more support rollers 120a, 120b coupled to the ends of the compression member 110 to support and/or help facilitate a rotation of the compression member 110. The support roller 120 may have a generally elongated cylindrical shape and may be rotated about rotational axis A1. The support roller 120 may be constructed of a resilient and/or non-resilient material. However, the present general inventive concept is not limited thereto.

Referring now to FIGS. 2 and 3, in the present exemplary embodiment, the variable compression apparatus 100 includes a first support roller 120a coupled to the first end 112 of the compression member 110 and a second support roller 120b coupled to the second end 114 of the compression member 110. The first and second support rollers 120a, 120b are configured to support the user's target area 10 (not illustrated) received within the recessed portion 116 and the compression member 110, while the compression member 110 is being rotated.

In exemplary embodiments, the support members 120a, 120b may be formed in various shapes (e.g., cylindrical, parabolic, conical) from all types of materials. In addition, the support members 120a, 120b may be constructed from a single resilient material having a single density or may be constructed from a plurality of different materials having varying densities. In exemplary embodiments, the compression member 110 may be formed in various other shapes including a cylindrical shape, an elliptical shape, and a circular shape. However, the present general inventive concept is not limited thereto.

The recessed portion 116 disposed between the first and second ends 112, 114 of the compression member 110 may include one or more force application regions 110a, 110b, 110c, and 110d configured to receive a target area 10 of a user's body and to gradually apply a force to the received target area 10 when the compression member 110 is rotated about the rotational axis A1. As the variable compression apparatus 100 is rotated, the received target area 10 is introduced to the one or more force application regions 110a, 110b, 110c, and 110d of the compression member 110.

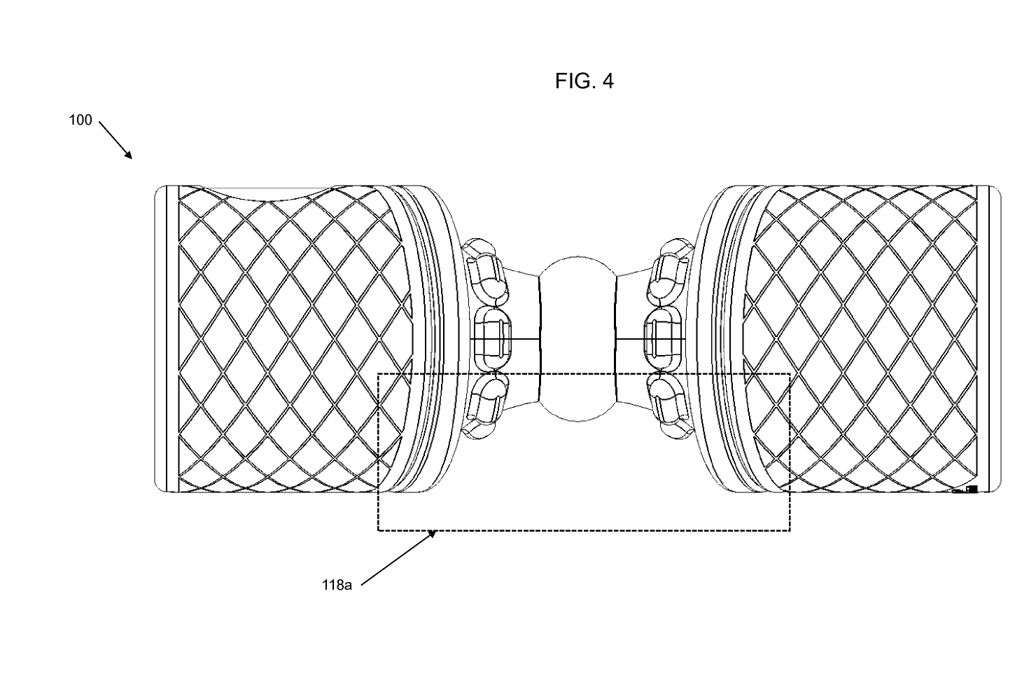

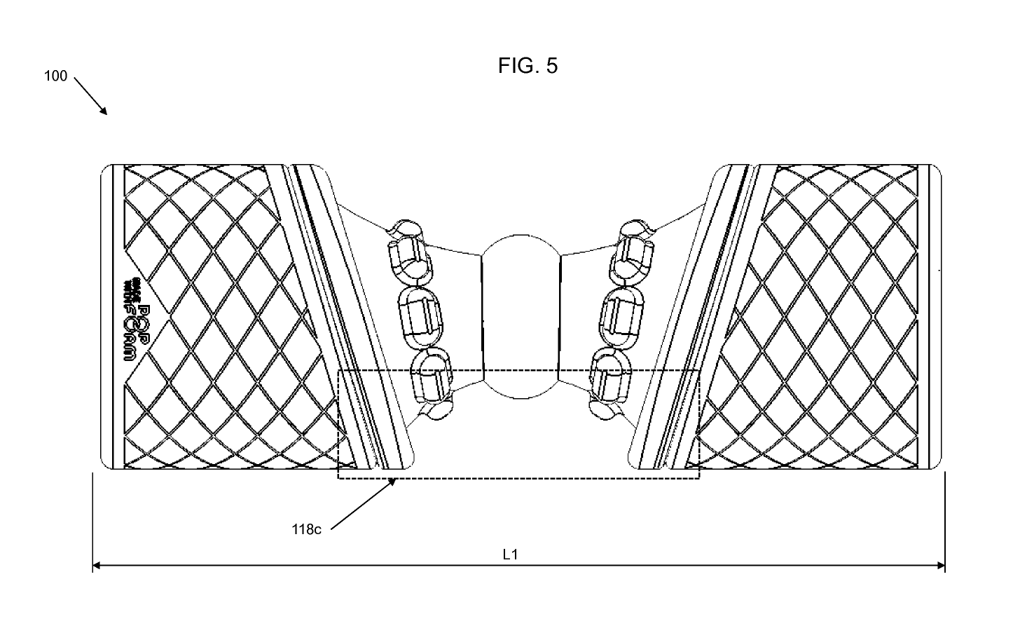

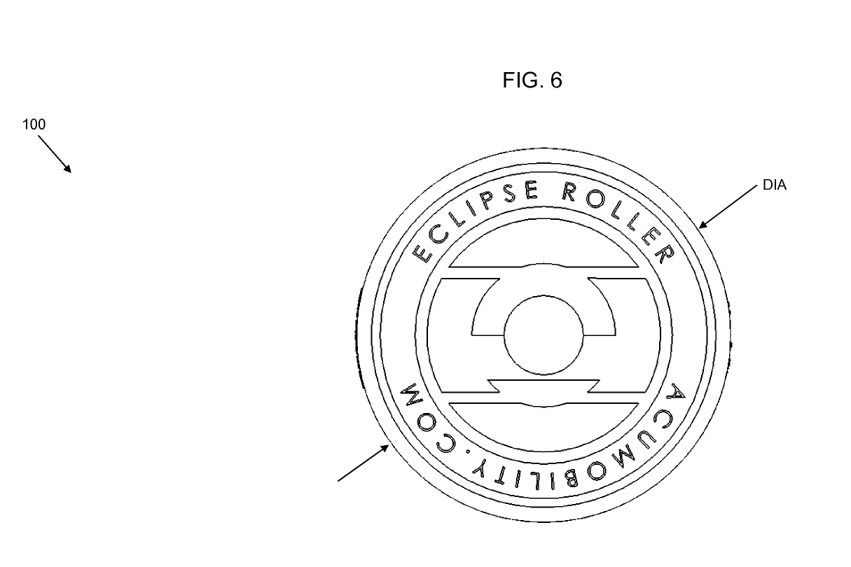

FIG. 4 is a bottom view of the variable compression roller apparatus 100 illustrated in FIG. 1. FIG. 5 is a front view of the variable compression apparatus 100 illustrated in FIG. 1 and FIG. 6 is a side view of the variable compression apparatus 100 illustrated in FIG. 1.

In exemplary embodiments, referring to FIGS. 2 through 5, the recessed portion 116 of the compression member 110 includes a first force application zone 118a configured to apply a first force, a second force application zone 118b configured to apply a second force, and a third force application zone 118c configured to apply a third force, when the compression member 110 is rotated. However, the present general inventive concept is not limited thereto. That is, in alternative exemplary embodiments, the compression member 110 may include a plurality of different force application zones, when rotated.

The plurality of pressure zones 118a, 118b, 118c (e.g., force application zones) are configured to apply different amounts of force and/or pressure to various muscle groups or target areas 10 from various different angles. For instance, the recessed portion 116 includes a first pressure zone 118a configured to apply a first amount of force and/or pressure to a desired target areas, a second pressure zone 118b configured to apply a second amount of force and/or pressure to the desired target area 10, and a third pressure zone 118c configured to apply a third amount of force and/or pressure to the desired target area 10.

In the present exemplary embodiment, the third force may be greater in magnitude than the first and second forces, and the second force may be greater than the first force. However, the present general inventive concept is not limited thereto. In exemplary embodiments, the first, second, and third forces applied to the target area 10 may include variable compressive forces that vary (e.g., gradually) when the compression member 110 is rotated from the first force application zone 118a to the second and third force application zones 118b, 118c.

In the present exemplary embodiment, the recessed portion 116 may be configured to apply varying amounts of force to the received target area 10 when the compression member 110 is rotated. The recessed portion 116 may include a circumferential groove or path which extends around the compression member 110 and is configured to receive a target area 10 of a user's body.

The recessed portion 116 may be formed in various shapes (e.g., u-shaped, v-shaped, c-shaped, or variations thereof) in order to accommodate and/or receive various target areas 10 of a user's body. The user may simply rotate the compression member 110, while the desired target area 10 is received within the recessed portion 116, to change between the first amount of force applied from the first pressure zone 118a, the second amount of force applied from the second pressure zone 118b, and the third amount of force applied from the third pressure zone 118c.

That is, in exemplary embodiments, as the compression member 110 rotates from the first pressure zone 118 to the second and third pressure zones 118b, 118c, the force applied to the target area 10 gradually increases from the first amount of force to the second and third amounts.

Referring to FIGS. 4 and 6, in an exemplary embodiment, a variable compression roller apparatus 100 including first and second support rollers 120a, 120b coupled to the first and second ends 112, 114, respectively, of a compression member 110 may have a longitudinal length L1 between 5 and 35 inches and a diameter DIA between 2 and 15 inches. However, the present general inventive concept is not limited thereto. In the present exemplary embodiment, the longitudinal length L1 of the compression member 110 coupled to the first and second support rollers 120a, 120b is about 18 inches with a diameter of about 6.5 inches.

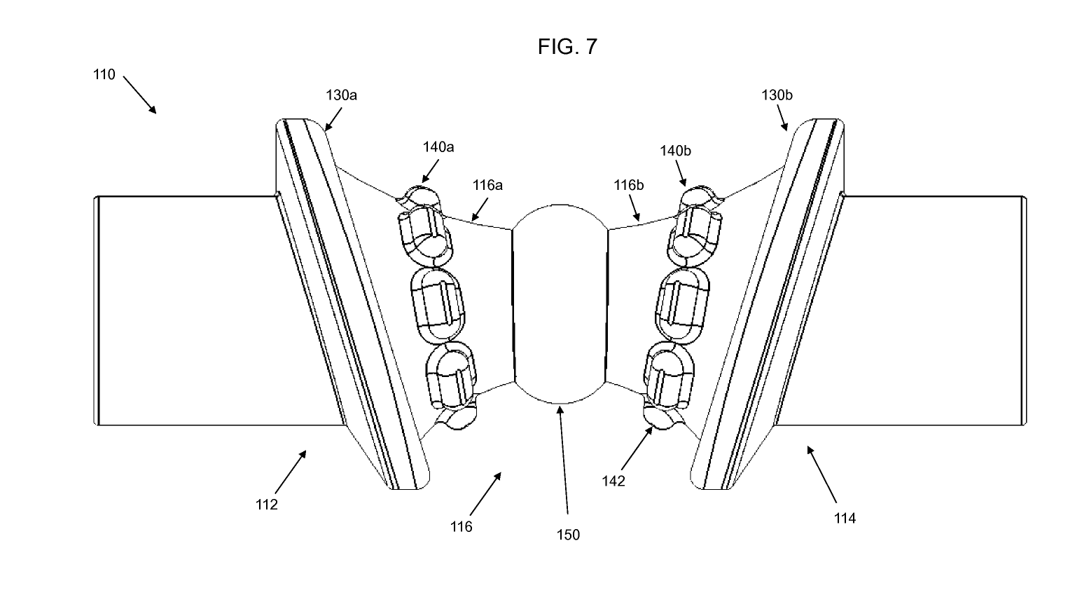

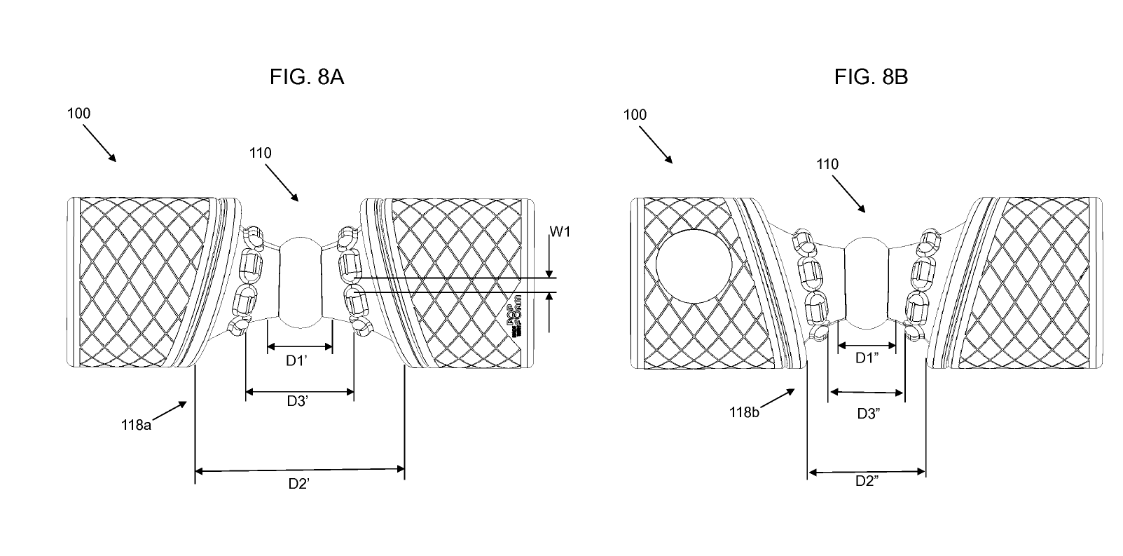

FIG. 7 is a front view of a compression member 110 according to an exemplary embodiment of the present general inventive concept. FIG. 8A is a front view illustrating a first pressure zone of a variable compression apparatus 100 according to an exemplary embodiment of the present inventive concept. FIG. 8B is a rotated front view illustrating a third pressure zone of the variable compression apparatus illustrated in FIG. 8A.

Referring now to FIGS. 7, 8A, and 8B, the recessed portion 116 of the compression member 110 includes side walls 116a, 116b which are configured to apply a compressive force (i.e., a first compressive force Fl) to a user's target area 10 placed or received within the recessed portion 116, when the compression member 110 is rotated. In exemplary embodiments, the sidewalls 116a, 116b of the compression member 110 may be formed and shaped so as to apply a force to the target area 10 which gradually increases during a rotation of the compression member 110.

In the present exemplary embodiment, the sidewalls 116a, 116b are able to provide a gradually increasing amount of force to the target area 10 by gradually reducing a dimension D1 between opposing sidewalls 116a and 116b, when the compression member 120 is rotated.

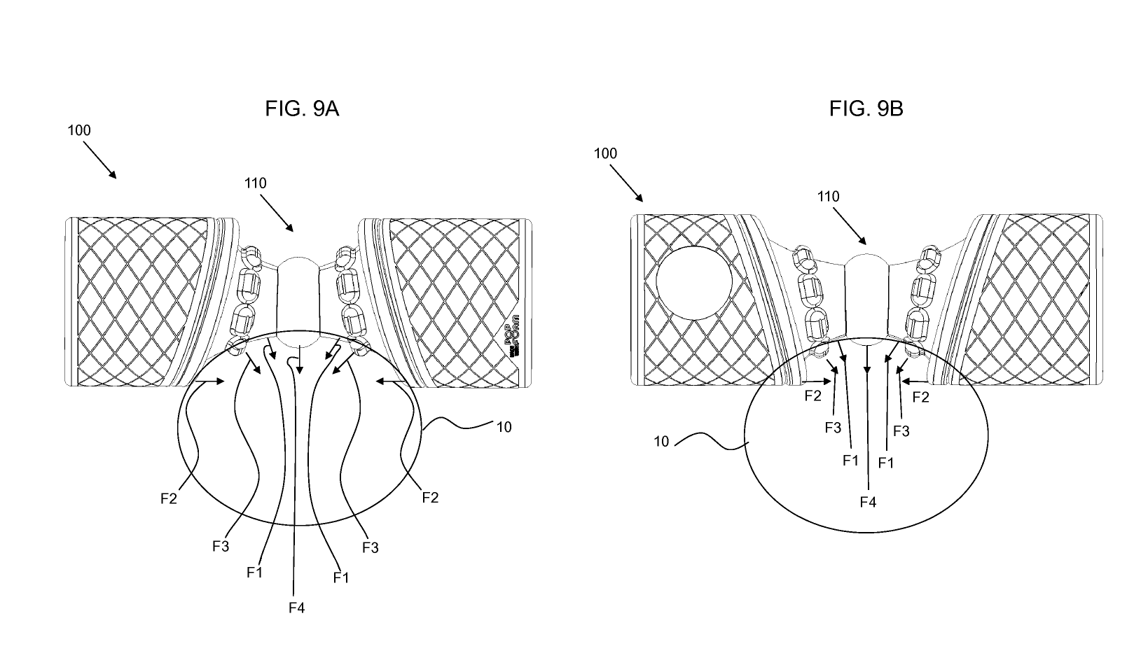

FIG. 9A is a schematic front view illustrating a target area disposed within the first pressure zone of the variable compression apparatus illustrated in FIG. 8A. FIG. 9B is a schematic front view illustrating a target area disposed within the third pressure zone of the variable compression apparatus illustrated in FIG. 8A.

The compression member 110 may further include one or more lateral pressure strips 130 disposed along a circumference of the recessed portion 116 which are configured to apply a lateral compressive force (i.e., a second compressive force F2) to the target area 10 placed or received within the recessed portion 116, when the compression member 120 is rotated. In exemplary embodiments, the compression member 110 includes a first lateral pressure strip 130a disposed toward the first end 112 of the compression member 110 and a second lateral pressure strip 130b disposed toward the second end 114 of the compression member 110.

In exemplary embodiments, the first and second lateral pressure strips 130a, 130b are configured or designed to gradually apply an increasing amount of lateral force F2 to the target area 10 placed within the recessed portion 116, when the compression member 110 is being rotated. That is, the first and second lateral pressure strips 130a, 130b are able to provide a gradually increasing amount of force by gradually reducing a dimension D2 between the first and second lateral pressure strips 130a, 130b.

In exemplary embodiments, the compression member 110 may further include one or more variable pressure strips 140 disposed along a circumference of the recessed portion 116 which are configured to apply a compressive force (i.e., a variable compressive force F3) to the target area 10 placed within the recessed portion 116, when the compression member 110 is rotated. In exemplary embodiments, the compression member 110 includes a first variable pressure strip 140a disposed toward the first end 112 of the compression member 110 and a second variable pressure strip 140b disposed toward the second end 114 of the compression member 110.

In exemplary embodiments, the variable pressure strips 140a, 140b are designed to gradually apply an increasing amount of compressive force F3 to the target area 10 placed within the recessed portion 116, while the compression member 110 is being rotated. That is, the first and second variable pressure strips 140a, 140b are configured to provide a gradually increasing amount of force by gradually reducing a dimension D3 between the first and second variable pressure strips 140a, 140b.

In the present exemplary embodiment, the first and second variable pressure strips 140a, 140b each include a plurality of pressure application members 142 which are sized, shaped, and/or positioned on the sidewall 116a, 116b of the compression member 110 so as to achieve various types of therapeutic massages and/or soft tissue manipulations. For instance, adjacent pressure application members 142 may be spaced apart a predetermined distance or width W1 so as to provide a desired squeezing and/or releasing technique on a target area. However, the present general inventive concept is not limited thereto. That is, in alternative exemplary embodiments, the first and the second variable pressure strips 140a, 140b may be formed with varying widths W1 between adjacent pressure application members 142 or may be formed as a single continuous strip.

In exemplary embodiments, the compression member 110 may further include one or more direct pressure strips 150 disposed along a circumference of the recessed portion 116 which are configured to apply a constant direct force (i.e., direct force F4) to the target area when placed within the recessed portion 116 and also when the compression member 110 is rotated. In the present exemplary embodiment, the direct pressure strip 140 is disposed along a circumference of the recessed portion 116 at a center between the first end 112 and the second end 114 of the compression member 110.

The variable compression roller apparatus 100 according to the present general inventive concept is designed so that the side walls 116a, the lateral pressure strips 120 and the variable pressure strips 130 each gradually apply an increasing amount of force to the target area placed within the recessed portion 116, while the compression member 110 is rotated. In addition, the direct pressure strip 140 applies a constant direct pressure force F4 to the target area concurrently or simultaneously with the side walls 116a, the lateral pressure strips 120 and the variable pressure strips 130 applying variable compressive forces to the target area, while the compression member 110 is rotated.

In the present exemplary embodiment, the compression member 110 is constructed of a single resilient or non-resilient material having a single density. However, the present general inventive concept is not limited thereto. That is, in alternative exemplary embodiments, the compression member 110 may be constructed from a plurality of materials having varying densities. For instance, the sidewalls 116a may be constructed from a first material having a first density and the lateral pressure strips 120, the variable pressure strips 130, and/or the direct pressure strip 140 formed on the sidewalls 116a of the compression member 110 may be constructed from a second material having a second density which is different than the first density.

Referring to FIGS. 8A and 8B, the dimension D1 between the sidewall 116a adjacent to the first end 112 and the sidewall 116b adjacent to the second end 114 may gradually decrease from D1′ to D1″ as the compression member 110 rotates, thereby gradually increasing an amount of force or pressure that the sidewalls 116a, 116b apply to a target area 10 received within the recessed 116. In exemplary embodiments, the side walls 116a, 116b may be constructed from various types of materials and formed in various shapes (e.g., conical, frusto-conical, u-shaped, v-shaped, c-shaped, or variations thereof) in order to accommodate and/or receive various target areas of a user's body and apply various amounts of pressure or force to the received target areas. However, the present general inventive concept is not limited thereto.

Similarly, the dimension D2 between the first lateral pressure strip 130a adjacent to the first end 112 and the second lateral pressure strip 130b adjacent to the second end 114 may gradually decrease from D2′ to D2″ as the compression member 110 rotates, thereby gradually increasing an amount of force or pressure that the first and second lateral pressure strips 130a, 130b apply to a target area 10 received within the recessed portion 116.

Likewise, the dimension D3 between the first variable pressure strip 140a adjacent to the first end 112 and the second variable pressure strip 140b adjacent to the second end 114 may gradually decrease from D3′ to D3″ as the compression member 110 rotates, thereby gradually increasing an amount of force or pressure that the first and second variable pressure strips 140a, 140b apply to a target area 10 received within the recessed portion 116.

In exemplary embodiments, the first pressure zone 118a may have a width of between 3 and 30 inches and the second pressure zone 118b may have a width of between 3 and 20 inches. However, the present general inventive concept is not limited thereto.

In the present exemplary embodiment, the compression member 110 has a first pressure zone 118a having a width of about 9 inches and a third pressure zone 118c having a width of about 4.5 inches. As illustrated in FIGS. 8A and 8B, the first pressure zone 118a gradually tapers into the second pressure zone 118b and into the third pressure zone 118c. However, the present general inventive concept is not limited thereto.

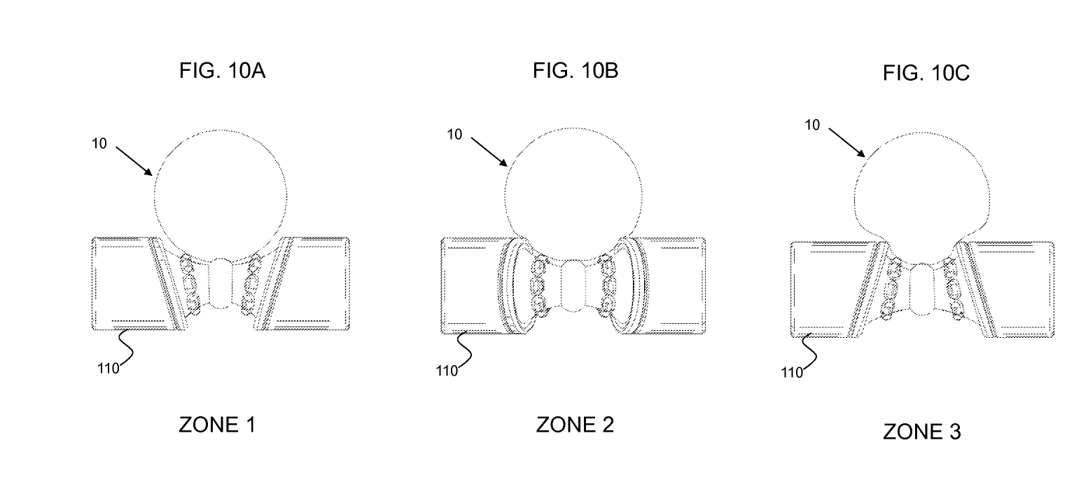

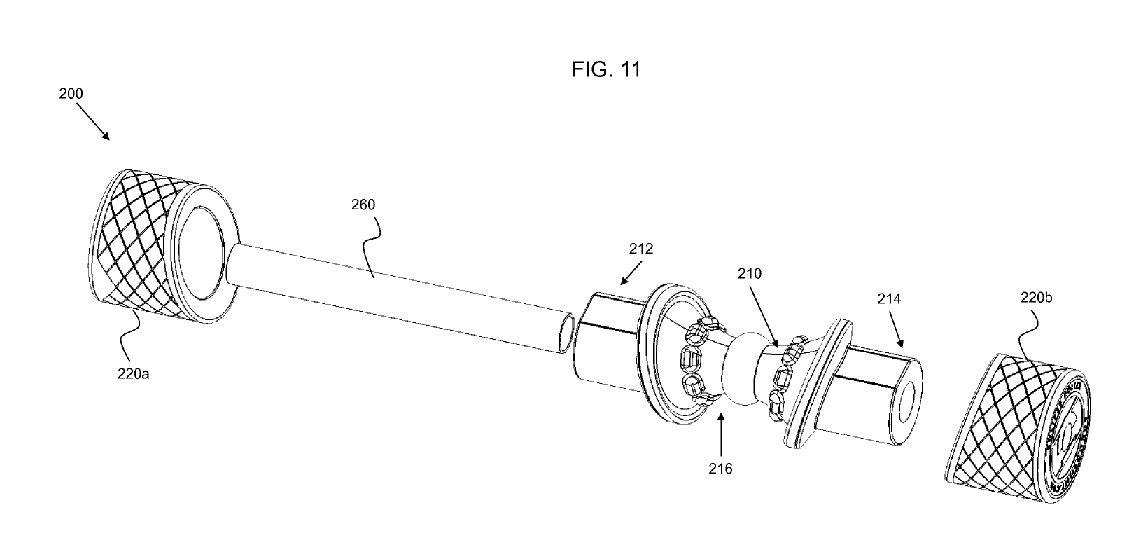

FIGS. 10A-10C are front views illustrating a variable compression apparatus 100 according to an exemplary embodiment of the present general inventive concept acting on a target area, during rotation;

Referring to FIGS. 10A-10C, a variable compression roller apparatus 100 is rotated about 360 degrees to illustrate a manner in which a compression member 110 gradually pulls and/or pushes on a target area 10 of a user within the various pressure zones (e.g., zone 1, zone 2, and zone 3). The compression member 110 gradually applies an increasing amount of force or pressure onto the target area 10, when rotated between first, second and third force application zones 118a, 118b, and 118c.

FIG. 11 is an exploded assembly perspective view of a variable compression apparatus 200 according to another exemplary embodiment of the present general inventive concept.

Referring to FIG. 11, in the present embodiment, the variable compression roller apparatus 200 includes a compression member 210 having a first end 212, an opposing second end 214, and a recessed portion 216 disposed between the first end 212 and the second end 214. The variable compression roller apparatus 200 includes a first support roller 250a coupled to the first end 212 and a second support roller 250b coupled to the second end 214. In addition, the variable compression roller apparatus 200 further includes a core member 260 which inserted within the compression member 210 and used to secure the first and second support rollers 220a, 220b to the compression member 210. In exemplary embodiments, the core member 260 may be formed in a hollow cylindrical shape from various types of materials. However, the present general inventive concept is not limited thereto. That is, in alternative exemplary embodiments, the core member 260 may be formed of a solid material having a predetermined weight so as to assist the compression member 210 in applying a force on the user's target area.

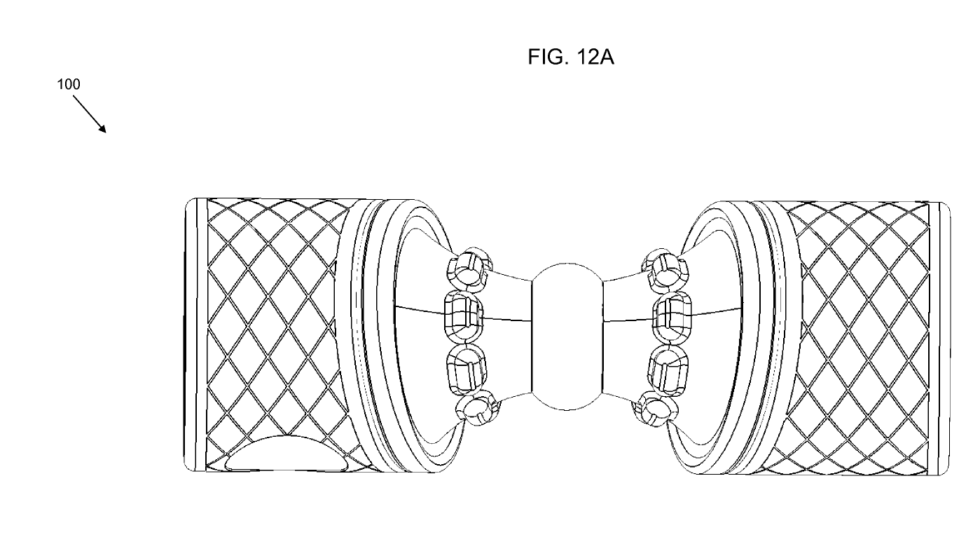

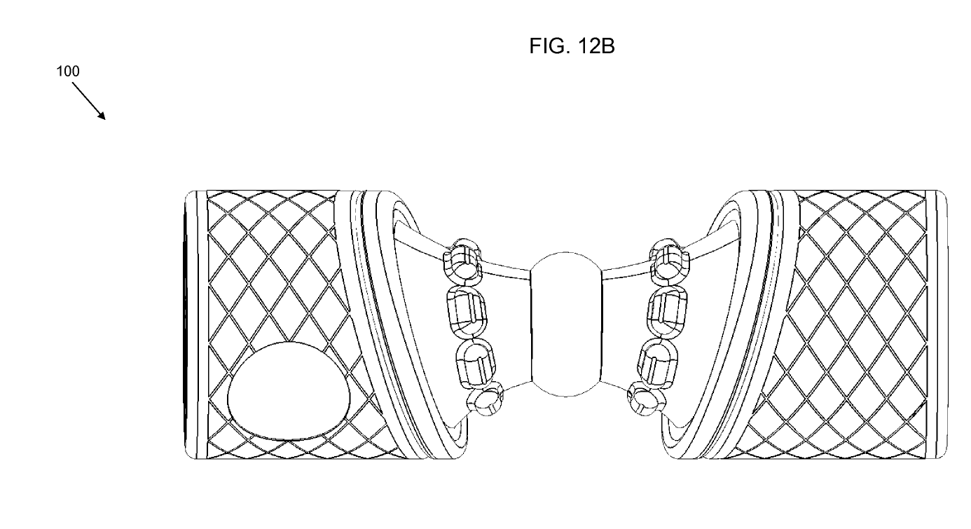

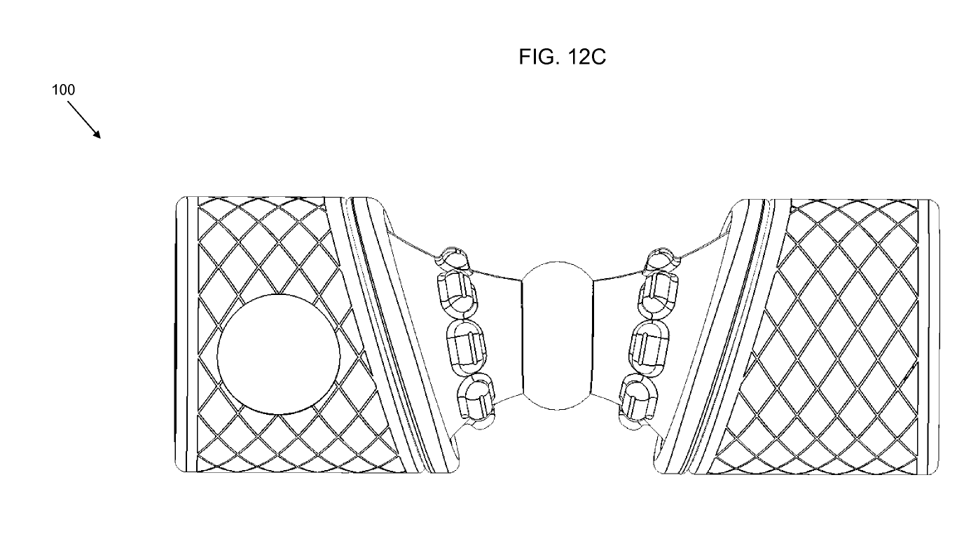

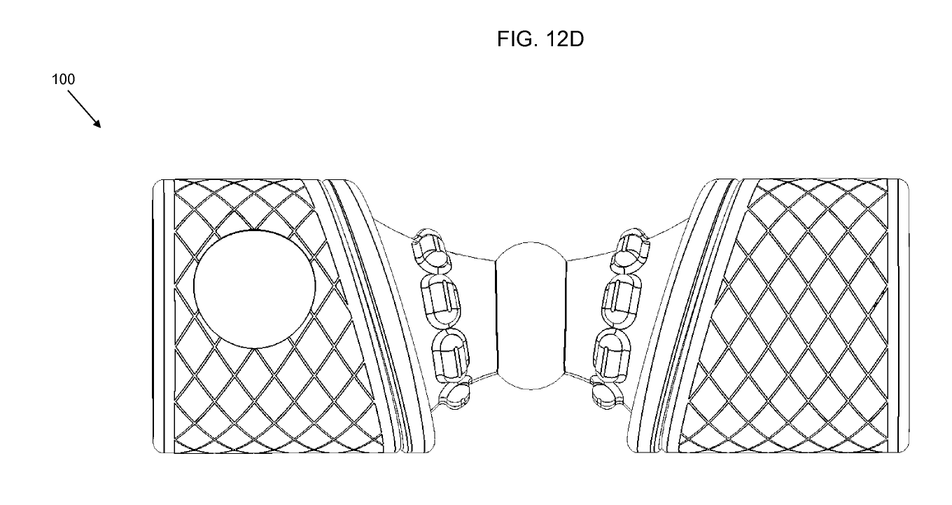

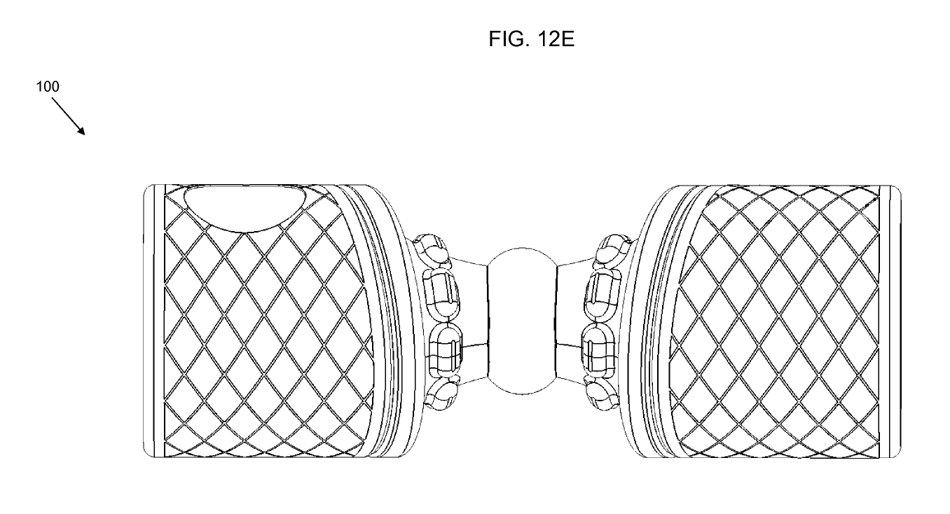

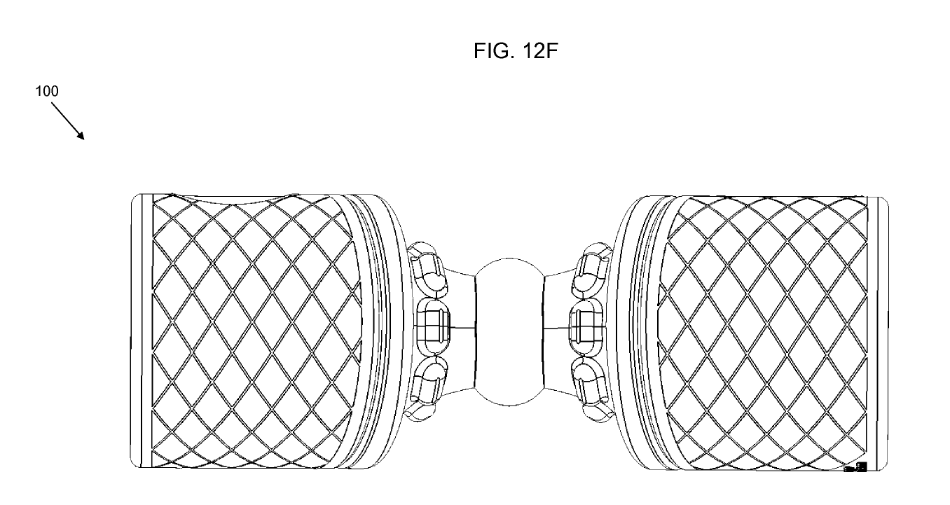

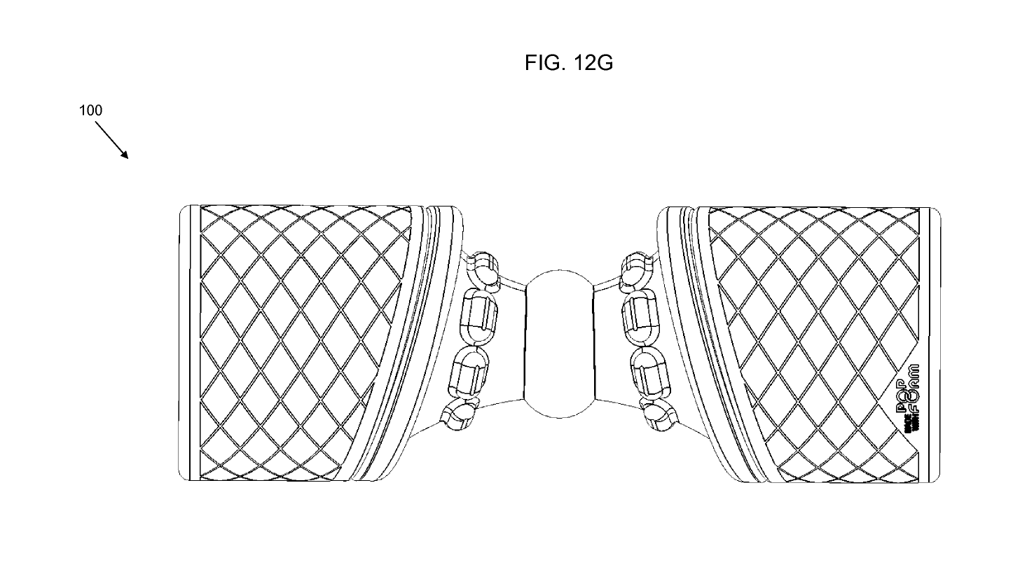

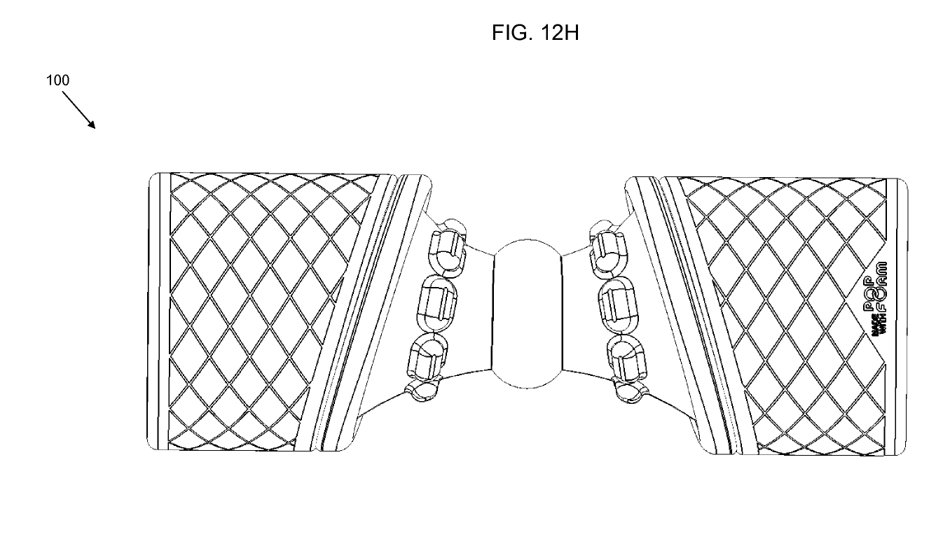

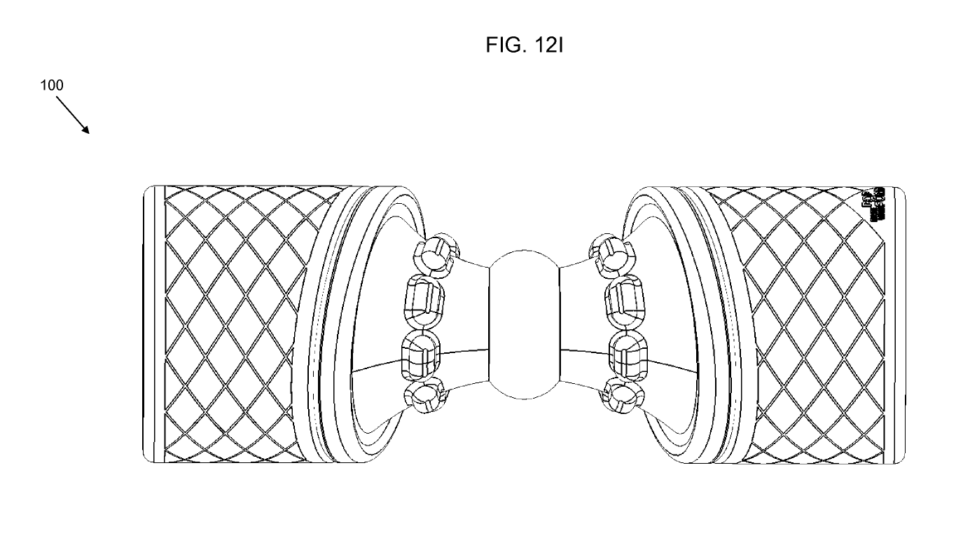

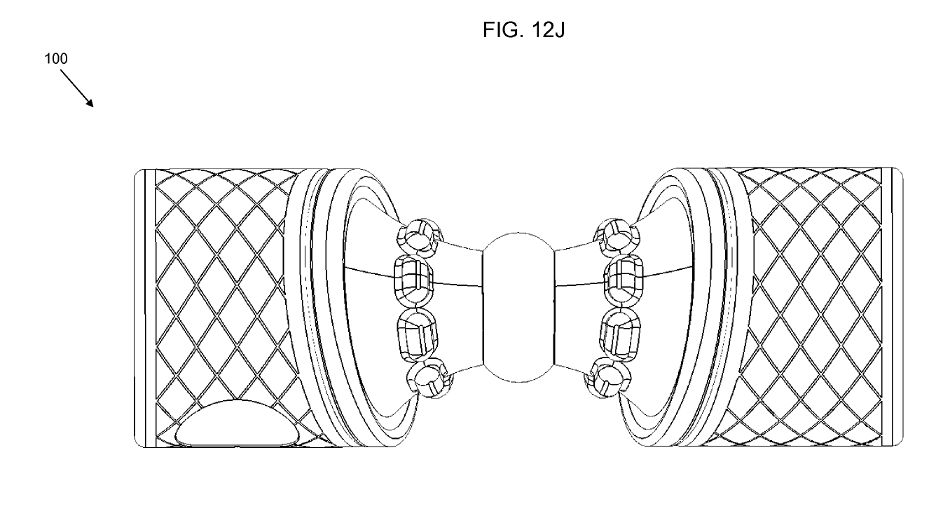

FIGS. 12A-12J are top plan views illustrating a variable compression roller apparatus 100 during a complete rotation according to an exemplary embodiment of the present general inventive concept.

Referring to FIGS. 12A-12J, a variable compression roller apparatus 100 is rotated over 360 degrees to illustrate a manner in which a first pressure zone 118a of the compression member 110 gradually tapers into the second pressure zone 118b and the third pressure zone 118c. In addition, FIGS. 10A-10J illustrate a gradual decrease in a dimensions between sidewalls 116a and 116b, first and second lateral pressure strips 130a and 130b, and first and second variable pressure strips 140a and 140b.

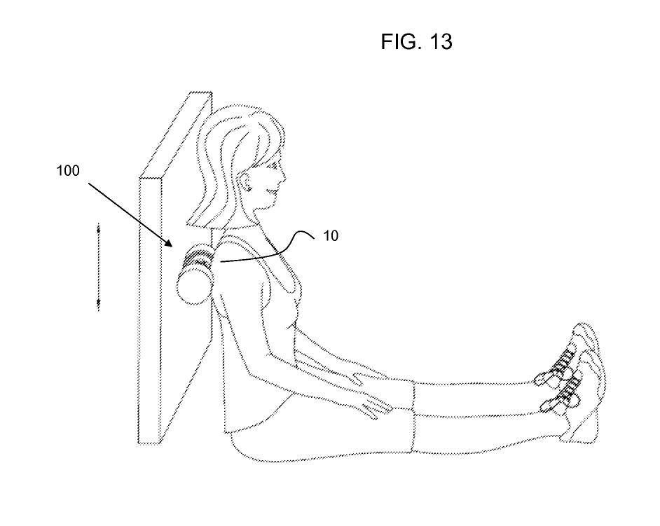

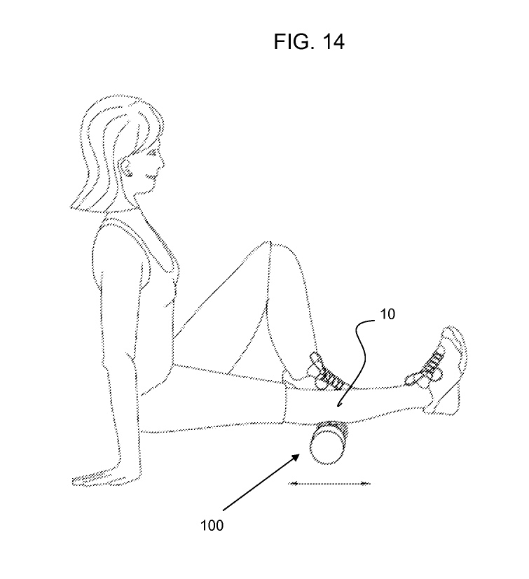

FIG. 13 is front perspective view illustrating a variable compression apparatus according to an exemplary embodiment of the present general inventive concept positioned under a user's leg (i.e., target area). FIG. 14 is front perspective view illustrating a variable compression apparatus according to an exemplary embodiment of the present general inventive concept positioned behind a user's shoulders (i.e., target area).

In use, a user places a variable compression roller apparatus on the floor or against a wall and presses his or her target area 10 against the variable compression roller apparatus 100. The user then moves the target area 10 back and forth against the variable compression roller apparatus such that the roller apparatus 100 applies a variable compressive force to the target area when the roller apparatus is rotated by the back and forth motion.

In an exemplary embodiment, a user places the variable compression roller apparatus 100 on the floor or against a wall and then presses his or her target area 10 (e.g., legs, arms, back, shoulders, etc.) against a compression member of the therapeutic tool. The user may then move the target area 10 back and forth against the therapeutic tool such that the tool simultaneously applies both a variable compressive force and a constant direct force to the target area 10, while the variable compression roller apparatus is rotated. However, the present general inventive concept is not limited thereto.

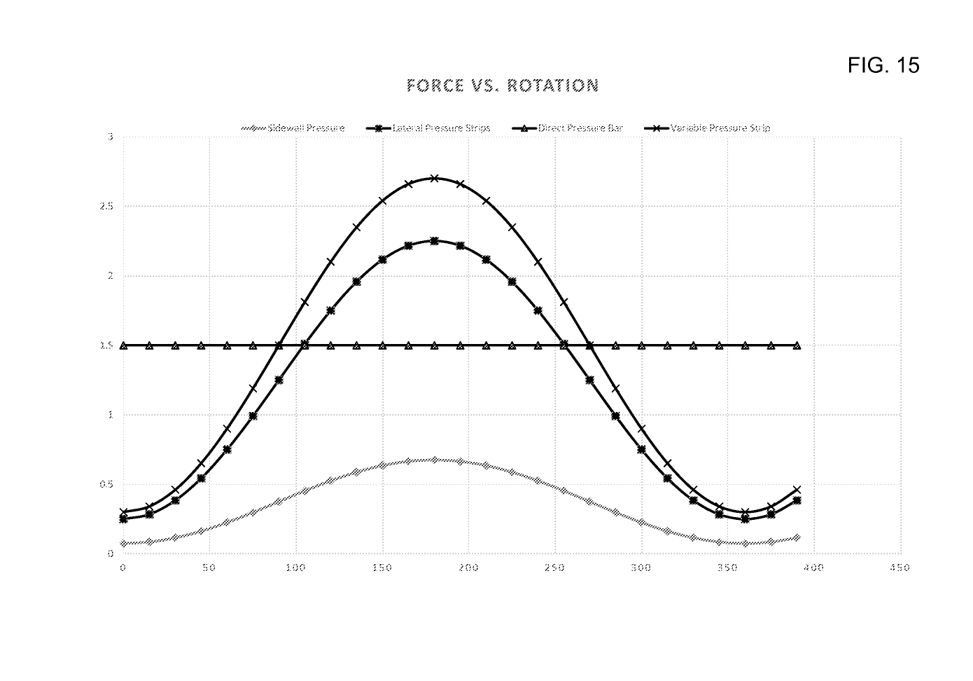

FIG. 15 is force versus rotation chart of a variable compression roller apparatus 100 according to an exemplary embodiment of the present general inventive concept.

Referring to FIG. 15, the chart illustrates the manner in which the variable compression roller apparatus 100 gradually increases an amount of force applied to a target area during a rotation of the compression member. In particular, the chart illustrates that the sidewalls 116a, 116b, the lateral pressure strips 130a, 130b, and the variable pressure strips 140a, 140b apply an initial pressure or force onto the target area 10 when the target area is placed within the recessed portion. The chart further illustrates that the direct pressure bar 150 applies a constant direct force to the target area during a complete rotation (e.g., 360 degrees) of the variable compression roller apparatus 100. In addition, the chart illustrates that when the compression member is rotated, the amounts of force applied by the sidewalls, the lateral pressure strips, and the variable pressure strips gradually increase until the compression member is rotated to about 180 degrees. The chart further illustrates that the amounts of force applied by the sidewalls, the lateral pressure strips, and the variable pressure strips gradually decrease from the 180 degree rotation until the compression member is rotated to about 360 degrees. However, the present general inventive concept is not limited thereto. That is, in alternative exemplary embodiments, the amounts and/or patterns of force applied to the target area by the sidewalls, the lateral pressure strips, the variable pressure strips, and/or the direct the direct pressure bar may vary as desired.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

What is claimed is:

1. A variable compression roller apparatus, comprising:
a compression member having a first end and an opposing second end and a recessed portion disposed between the first and second ends, the recessed portion having one or more force application zones configured to receive and apply a force to a target area of a user's body,
wherein the recessed portion applies a first force to the received target area when in a first force application zone and a second force when in a second force application zone.

2. The apparatus of claim 1, wherein a force applied by the recessed portion on the received target area changes from the first force to the second force when the compression member is rotated from the first force application zone to the second force application zone.

3. The apparatus of claim 1, wherein a force applied to the target area by the recessed portion is a variable compressive force which varies when the compression member is rotated.

4. The apparatus of claim 3, wherein the recessed portion includes a sidewall configured to apply a force to the received target area.

5. The apparatus of claim 4, wherein an amount of force applied by the sidewall to the received target area varies when the compression member is rotated.

6. The apparatus of claim 5, wherein a distance between points on the sidewall that are equidistant from a centerline of the compression member decreases from a first distance in the first force application zone to a second distance in the second force application zone.

7. The apparatus of claim 1, wherein the compression member further comprises one or more lateral pressure strips to apply a lateral force to the received target area.

8. The apparatus of claim 7, wherein the compression member includes a first lateral pressure strip disposed at the first end of the compression member and a second lateral pressure strip disposed at the second end of the compression member.

9. The apparatus of claim 8, wherein a distance between the first lateral pressure strip to the second lateral pressure strip decreases from a first distance in the first force application zone to a second distance in the second force application zone.

10. The apparatus of claim 1, wherein the compression member further comprises one or more variable pressure strips to apply a variable compression force to the received target area.

11. The apparatus of claim 10, wherein the compression member includes a first variable pressure strip having a plurality of pressure application members disposed at the first end of the compression member and a second variable pressure strip having a plurality of pressure application members disposed at the second end of the compression member.

12. The apparatus of claim 11, wherein the first and second variable pressure strips are configured to apply a release pattern of increasing to decreasing amounts of force to the received target area when the compression member is rotated.

13. The apparatus of claim 12, wherein a distance between the first variable pressure strip to the second variable pressure strip decreases from a first distance in the first force application zone to a second distance in the second force application zone.

14. The apparatus of claim 1, wherein the compression member further comprises a sidewall, a lateral pressure strip, and a variable pressure strip to apply varying amounts of force to the received target area when the compression member is rotated.

15. The apparatus of claim 14, wherein the compression member further includes a direct pressure bar member to apply a constant amount of direct force to the received target area, while the compression member is rotated.

16. A method of using a variable compression roller apparatus comprising a compression member having a first end and an opposing second end and a recessed portion disposed between the first and second ends, the recessed portion having one or more force application zones configured to receive and apply a force to a target area of a user's body, wherein the recessed portion applies a first force to the received target area when in a first zone and a second force when in a second zone, the method comprising:
placing the variable compression apparatus on a surface;
placing a user's target area within the recessed portion of the compression member; and
applying a force onto the compression member to rotate between the first force applied to the received target from the first zone and the second force applied to the received target area from the second zone.
